(19) United States
(12) Patent Application Publication
(10) Pub. No.: US 2023/0184971 A1
(43) Pub. Date: Jun. 15, 2023

(54) SIMULATING SPATIAL CONTEXT OF A DATASET

(71) Applicant: Saudi Arabian Oil Company, Dhahran (SA)

(72) Inventor: Bradley Clark Wallet, Norman, OK (US)

(21) Appl. No.: 17/643,989

(22) Filed: Dec. 13, 2021

(51) Int. Cl. G01V 1/28; G06N 3/08; G06N 3/04

(52) U.S. Cl. CPC G01V 1/282; G06N 3/08; G06N 3/0454

(57) ABSTRACT

Disclosed are methods, systems, and computer-readable medium to perform operations including: receiving an input dataset that represents partial spatial information of an area of interest; providing the input dataset to a spatial context generator, wherein the spatial context generator comprises a machine learning model trained to generate, based on the partial spatial information, contextual spatial information for the area of interest; and using the spatial context generator to generate, based on the partial spatial information, at least one output dataset associated with the area of interest, where each output dataset comprises simulated contextual spatial information for the area of interest.

### TECHNICAL FIELD

This description relates to methods and systems for simulating spatial context of a dataset.

### BACKGROUND

Producing hydrocarbon from a subsurface requires an understanding of the geology, structure, lithology, fluid properties, among other characteristics, of the subsurface One of the tools used for exploring these characteristics of the subsurface is seismic exploration.

In seismic exploration, seismic data is acquired and processed to form images of the subsurface. These images are then be interpreted. This interpretation is generally performed by a human interpreter. The interpreter uses knowledge of geology and geophysics, combined with interpreting experience, to develop an interpretation of the subsurface. This interpretation may include the construction of an earth model that is used for reservoir simulation. It may also include decisions about field development, such locations to drill future wells. Further, this interpretation may incorporate other information such as well logs and production data.

### SUMMARY

Aspects of the subject matter described in this specification may be embodied in methods that include the actions of involves receiving an input dataset that represents partial spatial information of an area of interest; providing the input dataset to a spatial context generator, where the spatial context generator involves a machine learning model trained to generate, based on the partial spatial information, contextual spatial information for the area of interest; using the spatial context generator to generate, based on the partial spatial information, at least one output dataset associated with the area of interest, where each output dataset includes simulated contextual spatial information for the area of interest.

In some implementations, the machine learning model is a conditional Generative Adversarial Network (cGAN).

In some implementations, the input dataset is a seismic dataset that represents the partial spatial information of the area of interest.

In some implementations, the input dataset is an input seismic cube that has a first dimension, and wherein each output dataset is an output seismic cube that has a second dimension larger than the first dimension.

In some implementations, the input dataset is a photographic image dataset that represents the partial spatial information of the area of interest.

In some implementations, the methods further involve training the machine learning model to generate, based on the partial spatial information, the contextual spatial information for the area of interest.

In some implementations, the machine learning model is a conditional Generative Adversarial Network (cGAN), and training the machine learning model involves training a generator network of the cGAN to generate the contextual spatial information for the area of interest based on the partial spatial information, where the generator network is trained based on feedback received from a discriminator network of the cGAN, and where the discriminator network is configured to distinguish between real data and simulated data generated by the generator network.

In some implementations, the real data and the simulated data are conditioned on training partial spatial information.

In some implementations, the methods further involve generating a model of the area of interest based on the at least one second seismic dataset.

The previously-described implementation is implementable using a computer-implemented method; a non-transitory, computer-readable medium storing computer-readable instructions to perform the computer-implemented method; and a computer system including a computer memory interoperably coupled with a hardware processor configured to perform the computer-implemented method or the instructions stored on the non-transitory, computer-readable medium. These and other embodiments may each optionally include one or more of the following features.

The subject matter described in this specification can be implemented in particular implementations so as to realize one or more of the following advantages. As an example, the disclosed methods and systems improve the performance of machine-learning based systems by increasing the amount of reliable training data. As another example, the disclosed methods and systems improve relevance of simulated data for training machine learning based systems by incorporating improved understanding of spatial context. As yet another example, the disclosed methods and systems improve performance of machine learning based systems due to a spatially contextualized incorporation of unlabeled data in the training process.

The details of one or more embodiments of these systems and methods are set forth in the accompanying drawings and the description below. Other features, objects, and advantages of these systems and methods will be apparent from the description and drawings, and from the claims.

### BRIEF DESCRIPTION OF THE DRAWINGS

FIG. 1 illustrates a block diagram of a Generative Adversarial Network (GAN), according to some implementations of the present disclosure.

FIG. 2 illustrates a block diagram of a conditional Generative Adversarial Network (cGAN), according to some implementations of the present disclosure.

FIG. 3 illustrates a block diagram of a simulation system, according to some implementations of the present disclosure.

FIG. 4 illustrates a block diagram of an example spatial context generator, according to some implementations of the present disclosure.

FIG. 5 illustrates a flowchart of an example method for generating a discriminant model, according to some implementations of the present disclosure.

FIG. 6 illustrates a flowchart of an example method for classifying geological processes using a discriminant model, according to some implementations of the present disclosure.

FIG. 7 illustrates a flowchart of an example method, according to some implementations of the present disclosure.

FIG. 8 is a block diagram of an example computer system, according to some implementations of the present disclosure.

Like reference numbers and designations in the various drawings indicate like elements.

### DETAILED DESCRIPTION

In line with the discussion above, seismic data interpretation is generally performed by a human interpreter. However, human interpretation of seismic data is labor intensive and is often prohibitively expensive. Human interpretation also has issues with repeatability and reliability. It is subject to the skill of the interpreter, the experience of the interpreter, the information available to the interpreter, among other factors. Due to these variable factors, different interpreters, perhaps even the same interpreter, can produce different interpretations of the same data at different times.

To deal with these shortcomings, the current industry trend is to use machine learning to augment or replace human interpretation. Machine learning is an increasingly established method of estimating an unknown state of nature based on training data. The training data includes data observations along with associated class information. From this data set, a model is then constructed that predicts unknown class membership for future observations. In the context of seismic data, a machine learning model can replace human interpretation. And the training data includes real seismic data and/or interpretations of seismic data (e.g., human interpretations of the seismic data).

However, modern machine learning algorithms, especially those that involve deep neural networks, often require very large amounts training data. Models are constructed to predict the unknown class because there is a cost to observing the class. In the case of seismic analysis, for example, that cost may be the time of an interpreter or the expense of drilling and logging a well. In many cases, the cost of obtaining a large training dataset may be prohibitively expensive. Historically, there have been a number of ways of dealing with this issue. One way is to absorb the cost. Another way is to crowdsource the cost by relying on a large number of individuals to contribute to the training data (e.g., by making images available on the Internet and asking people to provide interpretations).

Other ways of overcoming the cost include the use of alternative machine learning techniques. As an example, unsupervised learning techniques are methods that search for patterns in the data without using class information. In these techniques, the training algorithms estimate the existence and definitions of a class. Such techniques have the advantage of being capable of learning latent classes as suggested by the data. As another example, semi-supervised methods are capable of blending data with and without class labels to improve learning. These methods typically work by estimating class labels for the unclassified data and then incorporating these labels to varying degrees in the training process. However, because these techniques operate without or with limited supervision, the algorithms may not successfully learn the desired class information.

Disclosed herein are methods and systems for generating simulated seismic observations based on a limited set of seismic information. In one embodiment, the limited set of seismic information is a seismic dataset that represents partial spatial information of a subsurface. In this embodiment, partial spatial information is provided to a spatial context generator that is trained to generate one or more seismic datasets, each of which represents a possible geomorphological context for the partial spatial information. In one example, the spatial context generator is a form of a Generative Adversarial Network (GAN). As described in more detail below, the spatial context generator is trained by conditioning the training data on partial spatial information of subsurfaces.

This disclosure uses the terms “spatial information,” “partial spatial information,” “spatial context,” and “contextual spatial information.” “Spatial information” of a dataset, such as an image or seismic data, refers to information (e.g., material properties, features, data objects, shapes, etc.) in that dataset along a specified dimension in the dataset or information that has a specified location in the dataset (e.g., represented by coordinates or other positional information). The spatial information can be any dimension, e.g., 1-dimentional (1D), 2D, 3D, or 4D (e.g., time-lapse seismic data). “Partial spatial information” refers to spatial information of a portion of a feature or area within the dataset. For example, the partial spatial information of a geographic feature refers to spatial information of a portion of that geographic feature. “Contextual spatial information,” used interchangeably with “spatial context,” refers to spatial information in proximity of the partial spatial information, where the contextual spatial information provides additional information (i.e., context) missing from the partial spatial information. A properly contextualized dataset is one that includes “contextual spatial information” for one or more features within the dataset.

To understand the importance of spatial context, consider an example of three similar images of the Earth's surface, and particularly, bodies of water. A image is of a portion of a bay, another image is of section of a river, and the last image is of a section of a bayou. Because the images are from portions of bodies of water, the images are similar to one another. Subtle structures in the images can provide information about the underlying class, and an expert might be able to properly classify the images. However, the spatial context of the images provides considerably more information than just the representative portions. In this example, the fact that one of the images corresponds to a bay, another corresponds to a river, and another corresponds to a bayou provides more information than what is found in the images themselves (e.g., that the images are of a body of water). In the context of interpreting seismic and other geomorphological data, using context information is helpful for obtaining the desired outcome of accurately interpreting the data.

This disclosure provides methods and systems for generating geomorphological context to improve the use of machine learning in seismic interpretation. As stated above, in some embodiments, a Generative Adversarial Network (GAN), or a form thereof, is used to generate the geomorphological context. By way of background, a GAN includes two competing neural networks. One network, called a generator network, is trained to generate simulated data (also referred to as synthetic or artificial data). The other network, called a discriminator network, is trained to distinguish between the simulated and real data. The two networks are trained until a steady state is reached in which the discriminator network can no longer distinguish between the real and simulated data.

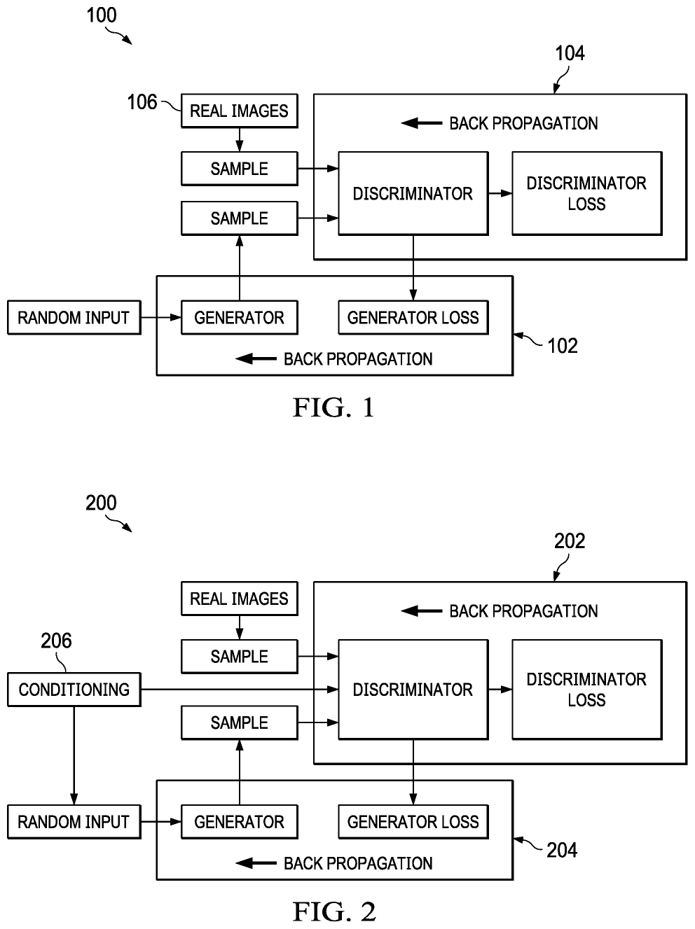

FIG. 1 illustrates a block diagram of a Generative Adversarial Network (GAN) 100, according to some implementations. As shown in FIG. 1, the GAN 100 includes a generator network 102 and a discriminator network 104. In the GAN 100, a set of real images 106 is sampled and provided as input to the discriminator network 104. Meanwhile, the generator network 102 generates simulated images, which are also sampled and provided as input to the discriminator network 104. The discriminator network 104 attempts to recognize which images are real and which images are fake or simulated. The two networks are trained to improve their respective loss functions, e.g., by using back propagation, until the discriminator network 104 can no longer distinguish between the real and simulated data.

An alternate form of GAN, called conditional GAN (cGAN), includes information that is available to both the generator and discriminator networks. The available information is related to the sampled images (that is, both the real and simulated images). In the cGAN, the images, both generated and real, are conditioned on the available information. As an example, the available information can be class labels. In this example, the training images can include class labels such as ‘horse’, ‘dog’, ‘cat’, and ‘armadillo.’ In this way, the generator network is trained to produce images of different classes as needed.

FIG. 2 illustrates a block diagram of a cGAN 100, according to some implementations. As shown in FIG. 2, like the GAN 100, the cGAN 200 includes a generator network 202 and a discriminator network 204. Also like the GAN 100, a set of real images 206 is sampled and provided as input to the discriminator network 204, and the generator network 202 generates simulated images that are also sampled and provided as input to the discriminator network 204. However, unlike the GAN 100, the cGAN 200 also includes conditioning information 208. The conditioning information 208 is provided to both networks such that both the simulated and real images are conditioned on the conditioning information 208.

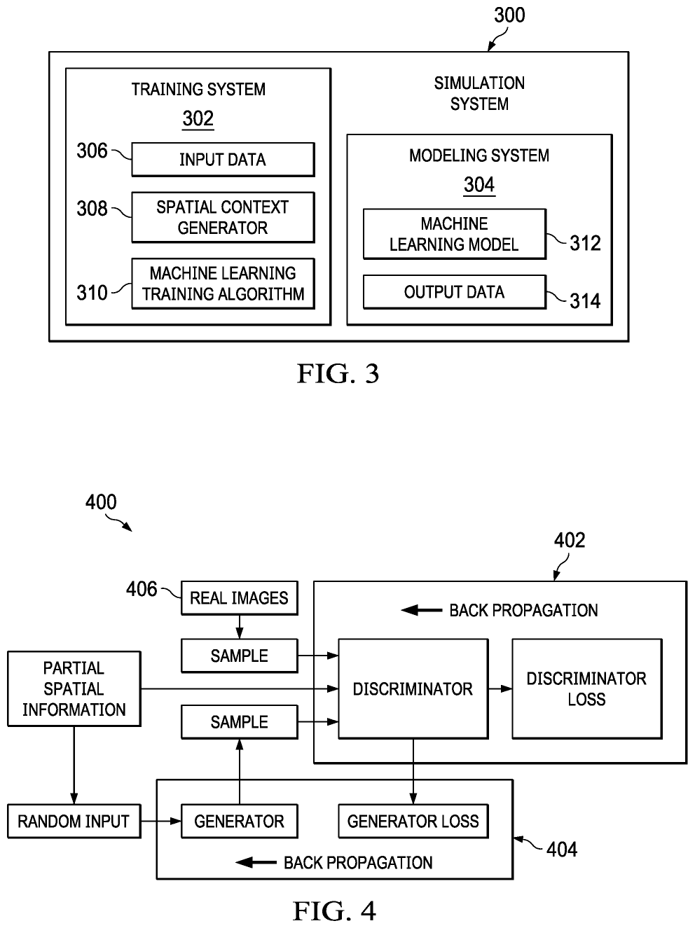

FIG. 3 illustrates a block diagram of a simulation system 300, according to some implementations. As shown in FIG. 3, the simulation system 300 includes a training system 302 and a modeling system 304. As described in more detail below, the training system 302 is configured to train a spatial context generator to generate properly contextualized datasets. Additionally, the training system 302 is configured to generate models based on the properly contextualized datasets, perhaps by using the properly contextualized datasets to train a machine learning algorithm. The modeling system 304 is configured to use the generated models to perform simulations, e.g., based on simulated or real input data. Within examples, the input/output datasets include images (e.g., of the Earth's surface), seismic data (e.g., of a subsurface), or both.

Note that the simulation system 300 is shown for illustration purposes only, as the simulation system 300 can include additional components or have one or more components removed without departing from the scope of the disclosure. Further, note that the various components of the simulation system 100 can be arranged or connected in any manner. For example, the training system 302 and the modeling system 304 can be implemented on the same computing device or can be implemented separately on different computing devices.

In some embodiments, the training system 302 is configured to receive input data 306. The input data 306 includes training data that is used to train a spatial context generator 308. In one example, the training data includes real data associated with one or more regions (e.g., Earth's surface or subsurface), partial spatial information associated with those regions, or both. The real data includes images (e.g., photographic images captured by a camera, seismic images, or seismic datasets). The partial spatial information includes individual observations of spatial information in a dataset (e.g., images or seismic data, geological models, well logs, well core data).

In some embodiments, the training system 302 uses the training data to train the spatial context generator 308 to generate properly contextualized datasets. In one example, as described below in FIG. 4, the spatial context generator 308 is a form of a conditional GAN. The training system 302 uses the input data 306 to train the spatial context generator 308 to generate one or more larger spatial data sets that are consistent with the one or more individual observations of spatial information. The larger spatial data sets are meant to simulate possible states of nature.

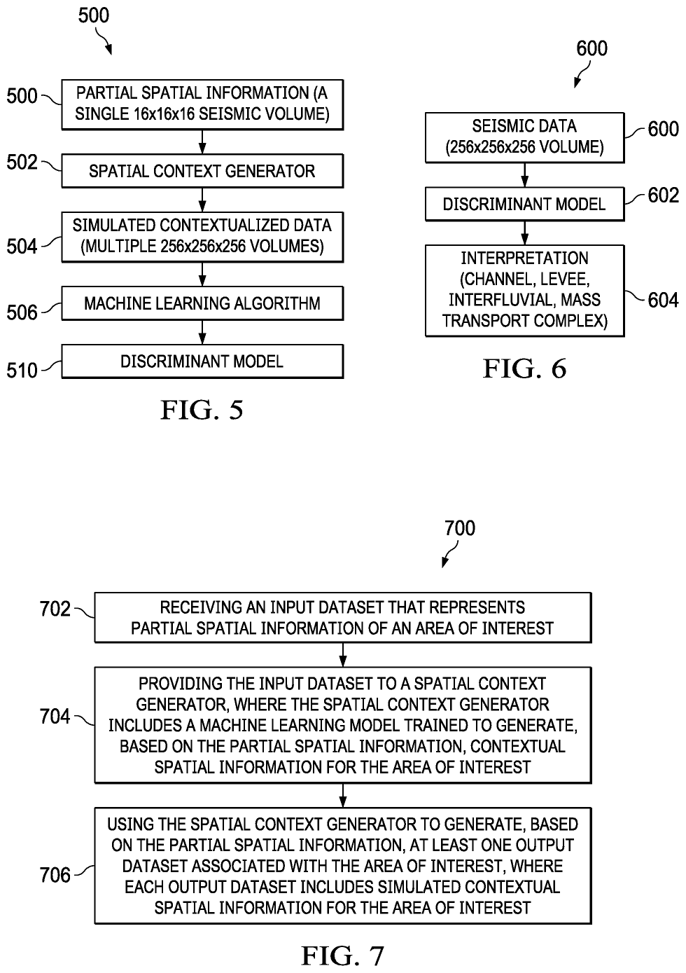

In some embodiments, once trained, the spatial context generator 308 can be used to generate training data for a machine learning algorithm 310. The machine learning algorithm 310 uses the generated training data to generate a discriminant model of a desired area (e.g., a surface or subsurface). An example workflow for training the spatial context generator 308 and generating the discriminant model is shown in FIG. 5 (described in more detail below). The discriminant model can be used by the modeling system 304 to perform simulations based on real or simulated data. For example, the discriminant model can be used to classify geological processes in the input data.

FIG. 4 illustrates an example spatial context generator 400, according to some implementations. In some embodiments, the spatial context generator 400 is based on a cGAN. In these embodiments, the spatial context generator 400 includes a discriminator network 402 and a generator network 404. As described previously, the generator network 402 generates fake or simulated images, which are sampled and provided as input to the discriminator network 404. The discriminator network 404 also receives real images 406 and attempts to identify which images are real and which images are fake. In one example, the real images 406 are dataset interpretations created by a human interpreter, where the dataset is a seismic dataset of a subsurface or an image of a surface.

In some embodiments, the generator network 404 is trained to generate datasets that are indistinguishable from the real images 406. In embodiments where the spatial context generator 400 is a cGAN, the discriminator network 402 and the generator network 404 also receive conditioning information that is used to condition the real and generated interpretations. In one example, the conditioning information is partial spatial information of the dataset. The partial spatial information is used to condition the real and simulated interpretations of the data. The discriminator network 402 and the generator network 404 are trained to improve their respective loss functions. Here, by conditioning the input data based on spatial information, the spatial context generator 400 can generate properly contextualized datasets. More specifically, the generator network 404 is trained to take datasets representing local geomorphology, and to generate larger datasets that have the represent a possible broader spatial context. As described in more detail below, the generated data sets of properly contextualized earth images or seismic data could be used as training data for a machine learning algorithm.

FIG. 5 illustrates a flowchart of an example method 500 for generating a discriminant model, according to some implementations. For clarity of presentation, the description that follows generally describes method 500 in the context of the other figures in this description. For example, method 500 can be performed by the training system 302 of FIG. 3. However, it will be understood that method 500 can be performed, for example, by any suitable system, environment, software, hardware, or a combination of systems, environments, software, and hardware, as appropriate. In some implementations, various steps of method 500 can be run in parallel, in combination, in loops, or in any order.

At 502, method 500 involves receiving partial spatial information associated with an area of interest. The area of interest can be a surface or subsurface. In examples where the area of interest is a subsurface, the partial spatial information is a single 16×16×16 seismic volume.

At 504, method 500 involves providing the partial spatial information to a spatial context generator. In one example, the spatial context generator is the spatial context generator 308 of FIG. 3.

At 506, method 500 involves using the spatial context generator to generate simulated contextualized data associated with the area of interest. In examples where the area of interest is a subsurface and the partial spatial information is a seismic dataset, the simulated contextualized data includes one or more 256×256×256 seismic volumes.

At 508, method 500 involves providing the simulated contextualized data as input to a machine learning algorithm, perhaps a convolutional neural network (CNN). Other machine learning algorithms are possible.

At 510, method 500 involves generating, using the machine learning algorithm, a discriminant model of the area of interest. As described in more detail below, the discriminant model can be used for simulating or classifying geological processes.

Turning back to FIG. 3, the modeling system 304 includes a machine learning model 312 that is trained by the training system 302. The machine learning model 312 may receive real or simulated input data, e.g., seismic data. The machine learning model 312 outputs an interpretation based on the input data. The output of the machine learning model 312 can be stored as output data 314. The machine learning model 312 is a classification method that assesses unknown states of nature. For example, given a seismic image, the machine learning model 312 can map out channels, pinnacle reefs, sand lobes, sweet spots, or any number of geological, petrophysical, or engineering features or regions of interest.

FIG. 6 illustrates a flowchart of an example method 600 for classifying geological processes using a discriminant model, according to some implementations. For clarity of presentation, the description that follows generally describes method 600 in the context of the other figures in this description. For example, method 600 can be performed by the modeling system 304 of FIG. 3. However, it will be understood that method 600 can be performed, for example, by any suitable system, environment, software, hardware, or a combination of systems, environments, software, and hardware, as appropriate. In some implementations, various steps of method 600 can be run in parallel, in combination, in loops, or in any order.

At 602, method 600 involves receiving input data. In one example, the input data is a seismic data volume (e.g., a 256×256×256 seismic volume).

At 604, method 600 involves using a discriminant model to perform a simulation based on the seismic data. In one example, the discriminant model is generated by a training system (e.g., the training system 302).

At 606, method 600 involves the discriminant model outputting the result of the simulation. In one example, the output of the simulation is a seismic interpretation, such as an identification of a channel, levee, interfluvial, and/or mass transport complex.

FIG. 7 illustrates a flowchart of an example method 700, according to some implementations. For clarity of presentation, the description that follows generally describes method 700 in the context of the other figures in this description. For example, method 700 can be performed by the simulation system 300 of FIG. 3. However, it will be understood that method 700 can be performed, for example, by any suitable system, environment, software, hardware, or a combination of systems, environments, software, and hardware, as appropriate. In some implementations, various steps of method 700 can be run in parallel, in combination, in loops, or in any order.

At step 702, method 700 involves receiving an input dataset that represents partial spatial information of an area of interest.

At step 704, method 700 providing the input dataset to a spatial context generator, where the spatial context generator involves a machine learning model trained to generate, based on the partial spatial information, contextual spatial information for the area of interest.

At step 706, method 700 involves using the spatial context generator to generate, based on the partial spatial information, at least one output dataset associated with the area of interest, where each output dataset includes simulated contextual spatial information for the area of interest.

In some implementations, the machine learning model is a conditional Generative Adversarial Network (cGAN).

In some implementations, the input dataset is a seismic dataset that represents the partial spatial information of the area of interest.

In some implementations, the input dataset is an input seismic cube that has a first dimension, and wherein each output dataset is an output seismic cube that has a second dimension larger than the first dimension.

In some implementations, the input dataset is a photographic image dataset that represents the partial spatial information of the area of interest.

In some implementations, method 700 further involves training the machine learning model to generate, based on the partial spatial information, the contextual spatial information for the area of interest.

In some implementations, the machine learning model is a conditional Generative Adversarial Network (cGAN), and training the machine learning model involves training a generator network of the cGAN to generate the contextual spatial information for the area of interest based on the partial spatial information, where the generator network is trained based on feedback received from a discriminator network of the cGAN, and where the discriminator network is configured to distinguish between real data and simulated data generated by the generator network.

In some implementations, the real data and the simulated data are conditioned on training partial spatial information.

In some implementations, method 700 further involves generating a model of the area of interest based on the at least one second seismic dataset.

In some implementations, the area of interest is at least one of a surface or subsurface.

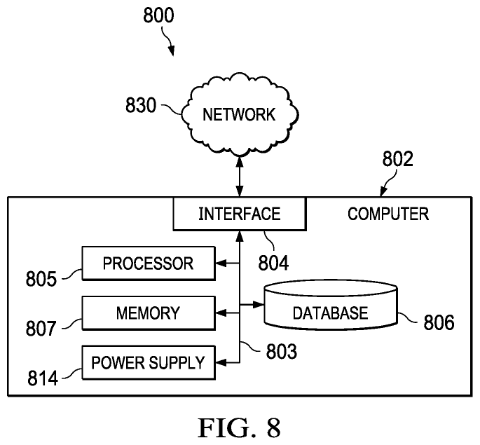

FIG. 8 is a block diagram of an example computer system 800 that can be used to provide computational functionalities associated with described algorithms, methods, functions, processes, flows, and procedures described in the present disclosure, according to some implementations of the present disclosure. In some implementations,

The illustrated computer 802 is intended to encompass any computing device such as a server, a desktop computer, an embedded computer, a laptop/notebook computer, a wireless data port, a smart phone, a personal data assistant (PDA), a tablet computing device, or one or more processors within these devices, including physical instances, virtual instances, or both. The computer 802 can include input devices such as keypads, keyboards, and touch screens that can accept user information. Also, the computer 802 can include output devices that can convey information associated with the operation of the computer 802. The information can include digital data, visual data, audio information, or a combination of information. The information can be presented in a graphical user interface (UI) (or GUI). In some implementations, the inputs and outputs include display ports (such as DVI-I+2× display ports), USB 3.0, GbE ports, isolated DI/O, SATA-III (6.0 Gb/s) ports, mPCIe slots, a combination of these, or other ports. In instances of an edge gateway, the computer 802 can include a Smart Embedded Management Agent (SEMA), such as a built-in ADLINK SEMA 2.2, and a video sync technology, such as Quick Sync Video technology supported by ADLINK MSDK+. In some examples, the computer 802 can include the MXE-5400 Series processor-based fanless embedded computer by ADLINK, though the computer 802 can take other forms or include other components.

The computer 802 can serve in a role as a client, a network component, a server, a database, a persistency, or components of a computer system for performing the subject matter described in the present disclosure. The illustrated computer 802 is communicably coupled with a network 830. In some implementations, one or more components of the computer 802 can be configured to operate within different environments, including cloud-computing-based environments, local environments, global environments, and combinations of environments.

At a high level, the computer 802 is an electronic computing device operable to receive, transmit, process, store, and manage data and information associated with the described subject matter. According to some implementations, the computer 802 can also include, or be communicably coupled with, an application server, an email server, a web server, a caching server, a streaming data server, or a combination of servers.

The computer 802 can receive requests over network 830 from a client application (for example, executing on another computer 802). The computer 802 can respond to the received requests by processing the received requests using software applications. Requests can also be sent to the computer 802 from internal users (for example, from a command console), external (or third) parties, automated applications, entities, individuals, systems, and computers.

Each of the components of the computer 802 can communicate using a system bus. In some implementations, any or all of the components of the computer 802, including hardware or software components, can interface with each other or the interface 804 (or a combination of both), over the system bus. Interfaces can use an application programming interface (API) 812, a service layer 813, or a combination of the API 812 and service layer 813. The API 812 can include specifications for routines, data structures, and object classes. The API 812 can be either computer-language independent or dependent. The API 812 can refer to a complete interface, a single function, or a set of APIs 812.

The service layer 813 can provide software services to the computer 802 and other components (whether illustrated or not) that are communicably coupled to the computer 802. The functionality of the computer 802 can be accessible for all service consumers using this service layer 813. Software services, such as those provided by the service layer 813, can provide reusable, defined functionalities through a defined interface. For example, the interface can be software written in JAVA, C++, or a language providing data in extensible markup language (XML) format. While illustrated as an integrated component of the computer 802, in alternative implementations, the API 812 or the service layer 813 can be stand-alone components in relation to other components of the computer 802 and other components communicably coupled to the computer 802. Moreover, any or all parts of the API 812 or the service layer 813 can be implemented as child or sub-modules of another software module, enterprise application, or hardware module without departing from the scope of the present disclosure.

The computer 802 can include an interface 804. Although illustrated as a single interface 804 in FIG. 8, two or more interfaces 804 can be used according to particular needs, desires, or particular implementations of the computer 802 and the described functionality. The interface 804 can be used by the computer 802 for communicating with other systems that are connected to the network 830 (whether illustrated or not) in a distributed environment. Generally, the interface 804 can include, or be implemented using, logic encoded in software or hardware (or a combination of software and hardware) operable to communicate with the network 830. More specifically, the interface 804 can include software supporting one or more communication protocols associated with communications. As such, the network 830 or the interface's hardware can be operable to communicate physical signals within and outside of the illustrated computer 802.

The computer 802 includes a processor 805. Although illustrated as a single processor 805 in FIG. 8, two or more processors 805 can be used according to particular needs, desires, or particular implementations of the computer 802 and the described functionality. Generally, the processor 805 can execute instructions and manipulate data to perform the operations of the computer 802, including operations using algorithms, methods, functions, processes, flows, and procedures as described in the present disclosure.

The computer 802 can also include a database 806 that can hold data for the computer 802 and other components connected to the network 830 (whether illustrated or not). For example, database 806 can be an in-memory, conventional, or a database storing data consistent with the present disclosure. In some implementations, the database 806 can be a combination of two or more different database types (for example, hybrid in-memory and conventional databases) according to particular needs, desires, or particular implementations of the computer 802 and the described functionality. Although illustrated as a single database 806 in FIG. 8, two or more databases (of the same, different, or combination of types) can be used according to particular needs, desires, or particular implementations of the computer 802 and the described functionality. While database 806 is illustrated as an internal component of the computer 802, in alternative implementations, database 806 can be external to the computer 802.

The computer 802 also includes a memory 807 that can hold data for the computer 802 or a combination of components connected to the network 830 (whether illustrated or not). Memory 807 can store any data consistent with the present disclosure. In some implementations, memory 807 can be a combination of two or more different types of memory (for example, a combination of semiconductor and magnetic storage) according to particular needs, desires, or particular implementations of the computer 802 and the described functionality. Although illustrated as a single memory 807 in FIG. 8, two or more memories 807 (of the same, different, or combination of types) can be used according to particular needs, desires, or particular implementations of the computer 802 and the described functionality. While memory 807 is illustrated as an internal component of the computer 802, in alternative implementations, memory 807 can be external to the computer 802.

An application 808 can be an algorithmic software engine providing functionality according to particular needs, desires, or particular implementations of the computer 802 and the described functionality. For example, an application 808 can serve as one or more components, modules, or applications 808. Multiple applications 808 can be implemented on the computer 802. Each application 808 can be internal or external to the computer 802.

The computer 802 can also include a power supply 814. The power supply 814 can include a rechargeable or non-rechargeable battery that can be configured to be either user- or non-user-replaceable. In some implementations, the power supply 814 can include power-conversion and management circuits, including recharging, standby, and power management functionalities. In some implementations, the power-supply 814 can include a power plug to allow the computer 802 to be plugged into a wall socket or a power source to, for example, power the computer 802 or recharge a rechargeable battery.

There can be any number of computers 802 associated with, or external to, a computer system including computer 802, with each computer 802 communicating over network 830. Further, the terms “client”, “user”, and other appropriate terminology can be used interchangeably without departing from the scope of the present disclosure. Moreover, the present disclosure contemplates that many users can use one computer 802 and one user can use multiple computers 802.

Implementations of the subject matter and the functional operations described in this specification can be implemented in digital electronic circuitry, in tangibly embodied computer software or firmware; in computer hardware, including the structures disclosed in this specification and their structural equivalents; or in combinations of one or more of them. Software implementations of the described subject matter can be implemented as one or more computer programs. Each computer program can include one or more modules of computer program instructions encoded on a tangible, non-transitory, computer-readable computer-storage medium for execution by, or to control the operation of, data processing apparatus. Alternatively, or additionally, the program instructions can be encoded in/on an artificially generated propagated signal. For example, the signal can be a machine-generated electrical, optical, or electromagnetic signal that is generated to encode information for transmission to a suitable receiver apparatus for execution by a data processing apparatus. The computer-storage medium can be a machine-readable storage device, a machine-readable storage substrate, a random or serial access memory device, or a combination of computer-storage mediums.

The terms “data processing apparatus”, “computer”, and “electronic computer device” (or equivalent as understood by one of ordinary skill in the art) refer to data processing hardware. For example, a data processing apparatus can encompass all kinds of apparatuses, devices, and machines for processing data, including by way of example, a programmable processor, a computer, or multiple processors or computers. The apparatus can also include special purpose logic circuitry including, for example, a central processing unit (CPU), a field programmable gate array (FPGA), or an application specific integrated circuit (ASIC). In some implementations, the data processing apparatus or special purpose logic circuitry (or a combination of the data processing apparatus and special purpose logic circuitry) can be hardware- or software-based (or a combination of both hardware- and software-based). The apparatus can optionally include code that creates an execution environment for computer programs, for example, code that constitutes processor firmware, a protocol stack, a database management system, an operating system, or a combination of execution environments. The present disclosure contemplates the use of data processing apparatuses with or without conventional operating systems, for example, Linux, Unix, Windows, Mac OS, Android, or iOS.

A computer program, which can also be referred to or described as a program, software, a software application, a module, a software module, a script, or code can be written in any form of programming language. Programming languages can include, for example, compiled languages, interpreted languages, declarative languages, or procedural languages. Programs can be deployed in any form, including as stand-alone programs, modules, components, subroutines, or units for use in a computing environment. A computer program can, but need not, correspond to a file in a file system. A program can be stored in a portion of a file that holds other programs or data, for example, one or more scripts stored in a markup language document; in a single file dedicated to the program in question; or in multiple coordinated files storing one or more modules, sub programs, or portions of code. A computer program can be deployed for execution on one computer or on multiple computers that are located, for example, at one site or distributed across multiple sites that are interconnected by a communication network. While portions of the programs illustrated in the various figures may be shown as individual modules that implement the various features and functionality through various objects, methods, or processes; the programs can instead include a number of sub-modules, third-party services, components, and libraries. Conversely, the features and functionality of various components can be combined into single components as appropriate. Thresholds used to make computational determinations can be statically, dynamically, or both statically and dynamically determined.

The methods, processes, or logic flows described in this specification can be performed by one or more programmable computers executing one or more computer programs to perform functions by operating on input data and generating output. The methods, processes, or logic flows can also be performed by, and apparatus can also be implemented as, special purpose logic circuitry, for example, a CPU, an FPGA, or an ASIC.

Computers suitable for the execution of a computer program can be based on one or more of general and special purpose microprocessors and other kinds of CPUs. The elements of a computer are a CPU for performing or executing instructions and one or more memory devices for storing instructions and data. Generally, a CPU can receive instructions and data from (and write data to) a memory. A computer can also include, or be operatively coupled to, one or more mass storage devices for storing data. In some implementations, a computer can receive data from, and transfer data to, the mass storage devices including, for example, magnetic, magneto optical disks, or optical disks. Moreover, a computer can be embedded in another device, for example, a mobile telephone, a personal digital assistant (PDA), a mobile audio or video player, a game console, a global positioning system (GPS) receiver, or a portable storage device such as a universal serial bus (USB) flash drive.

Computer readable media (transitory or non-transitory, as appropriate) suitable for storing computer program instructions and data can include all forms of permanent/non-permanent and volatile/non-volatile memory, media, and memory devices. Computer readable media can include, for example, semiconductor memory devices such as random access memory (RAM), read only memory (ROM), phase change memory (PRAM), static random access memory (SRAM), dynamic random access memory (DRAM), erasable programmable read-only memory (EPROM), electrically erasable programmable read-only memory (EEPROM), and flash memory devices. Computer readable media can also include, for example, magnetic devices such as tape, cartridges, cassettes, and internal/removable disks. Computer readable media can also include magneto optical disks, optical memory devices, and technologies including, for example, digital video disc (DVD), CD ROM, DVD+/−R, DVD-RAM, DVD-ROM, HD-DVD, and BLURAY. The memory can store various objects or data, including caches, classes, frameworks, applications, modules, backup data, jobs, web pages, web page templates, data structures, database tables, repositories, and dynamic information. Types of objects and data stored in memory can include parameters, variables, algorithms, instructions, rules, constraints, and references. Additionally, the memory can include logs, policies, security or access data, and reporting files. The processor and the memory can be supplemented by, or incorporated in, special purpose logic circuitry.

Implementations of the subject matter described in the present disclosure can be implemented on a computer having a display device for providing interaction with a user, including displaying information to (and receiving input from) the user. Types of display devices can include, for example, a cathode ray tube (CRT), a liquid crystal display (LCD), a light-emitting diode (LED), or a plasma monitor. Display devices can include a keyboard and pointing devices including, for example, a mouse, a trackball, or a trackpad. User input can also be provided to the computer through the use of a touchscreen, such as a tablet computer surface with pressure sensitivity or a multi-touch screen using capacitive or electric sensing. Other kinds of devices can be used to provide for interaction with a user, including to receive user feedback, for example, sensory feedback including visual feedback, auditory feedback, or tactile feedback. Input from the user can be received in the form of acoustic, speech, or tactile input. In addition, a computer can interact with a user by sending documents to, and receiving documents from, a device that is used by the user. For example, the computer can send web pages to a web browser on a user's client device in response to requests received from the web browser.

The term “graphical user interface”, or “GUI”, can be used in the singular or the plural to describe one or more graphical user interfaces and each of the displays of a particular graphical user interface. Therefore, a GUI can represent any graphical user interface, including, but not limited to, a web browser, a touch screen, or a command line interface (CLI) that processes information and efficiently presents the information results to the user. In general, a GUI can include a plurality of user interface (UI) elements, some or all associated with a web browser, such as interactive fields, pull-down lists, and buttons. These and other UI elements can be related to or represent the functions of the web browser.

Implementations of the subject matter described in this specification can be implemented in a computing system that includes a back end component, for example, as a data server, or that includes a middleware component such as an application server. Moreover, the computing system can include a front-end component, for example, a client computer having one or both of a graphical user interface or a Web browser through which a user can interact with the computer. The components of the system can be interconnected by any form or medium of wireline or wireless digital data communication (or a combination of data communication) in a communication network. Examples of communication networks include a local area network (LAN), a radio access network (RAN), a metropolitan area network (MAN), a wide area network (WAN), Worldwide Interoperability for Microwave Access (WIMAX), a wireless local area network (WLAN) (for example, using 802.11 a/b/g/n or 802.20 or a combination of protocols), all or a portion of the Internet, or any other communication system or systems at one or more locations (or a combination of communication networks). The network can communicate with, for example, Internet Protocol (IP) packets, frame relay frames, asynchronous transfer mode (ATM) cells, voice, video, data, or a combination of communication types between network addresses.

The computing system can include clients and servers. A client and server can generally be remote from each other and can typically interact through a communication network. The relationship of client and server can arise by virtue of computer programs running on the respective computers and having a client-server relationship.

Cluster file systems can be any file system type accessible from multiple servers for read and update. Locking or consistency tracking may not be necessary since the locking of exchange file system can be done at application layer. Furthermore, Unicode data files can be different from non-Unicode data files.

While this specification contains many specific implementation details, these should not be construed as limitations on the scope of what may be claimed, but rather as descriptions of features that may be specific to particular implementations. Certain features that are described in this specification in the context of separate implementations can also be implemented, in combination, or in a single implementation. Conversely, various features that are described in the context of a single implementation can also be implemented in multiple implementations, separately, or in any suitable sub-combination. Moreover, although previously described features may be described as acting in certain combinations and even initially claimed as such, one or more features from a claimed combination can, in some cases, be excised from the combination, and the claimed combination may be directed to a sub-combination or variation of a sub-combination.

Particular implementations of the subject matter have been described. Other implementations, alterations, and permutations of the described implementations are within the scope of the following claims as will be apparent to those skilled in the art. While operations are depicted in the drawings or claims in a particular order, this should not be understood as requiring that such operations be performed in the particular order shown or in sequential order, or that all illustrated operations be performed (some operations may be considered optional), to achieve desirable results. In certain circumstances, multitasking or parallel processing (or a combination of multitasking and parallel processing) may be advantageous and performed as deemed appropriate.

Moreover, the separation or integration of various system modules and components in the previously described implementations should not be understood as requiring such separation or integration in all implementations; and it should be understood that the described program components and systems can generally be integrated together in a single software product or packaged into multiple software products.

Accordingly, the previously described example implementations do not define or constrain the present disclosure. Other changes, substitutions, and alterations are also possible without departing from the spirit and scope of the present disclosure.

Furthermore, any claimed implementation is considered to be applicable to at least a computer-implemented method; a non-transitory, computer-readable medium storing computer-readable instructions to perform the computer-implemented method; and a computer system comprising a computer memory interoperably coupled with a hardware processor configured to perform the computer-implemented method or the instructions stored on the non-transitory, computer-readable medium.

What is claimed is:

1. A method comprising:
receiving an input dataset that represents partial spatial information of an area of interest;
providing the input dataset to a spatial context generator, wherein the spatial context generator comprises a machine learning model trained to generate, based on the partial spatial information, contextual spatial information for the area of interest; and
using the spatial context generator to generate, based on the partial spatial information, at least one output dataset associated with the area of interest, wherein each output dataset comprises simulated contextual spatial information for the area of interest.

2. The method of claim 1, wherein the machine learning model is a conditional Generative Adversarial Network (cGAN).

3. The method of claim 1, wherein the input dataset is a seismic dataset that represents the partial spatial information of the area of interest.

4. The method of claim 1, wherein the input dataset is an input seismic cube that has a first dimension, and wherein each output dataset is an output seismic cube that has a second dimension larger than the first dimension.

5. The method of claim 1, wherein the input dataset is a photographic image dataset that represents the partial spatial information of the area of interest.

6. The method of claim 1, further comprising:
training the machine learning model to generate, based on the partial spatial information, the contextual spatial information for the area of interest.

7. The method of claim 6, wherein the machine learning model is a conditional Generative Adversarial Network (cGAN), and wherein training the machine learning model comprises:
training a generator network of the cGAN to generate the contextual spatial information for the area of interest based on the partial spatial information, wherein the generator network is trained based on feedback received from a discriminator network of the cGAN, and wherein the discriminator network is configured to distinguish between real data and simulated data generated by the generator network.

8. The method of claim 7, wherein the real data and the simulated data are conditioned on training partial spatial information.

9. The method of claim 1, further comprising:
generating a model of the area of interest based on the at least one second seismic dataset.

10. The method of claim 1, wherein the area of interest is at least one of a surface or subsurface.

11. A system comprising:
one or more processors configured to perform operations comprising:
receiving an input dataset that represents partial spatial information of an area of interest;
providing the input dataset to a spatial context generator, wherein the spatial context generator comprises a machine learning model trained to generate, based on the partial spatial information, contextual spatial information for the area of interest; and
using the spatial context generator to generate, based on the partial spatial information, at least one output dataset associated with the area of interest, wherein each output dataset comprises simulated contextual spatial information for the area of interest.

12. The system of claim 11, wherein the machine learning model is a conditional Generative Adversarial Network (cGAN).

13. The system of claim 11, wherein the input dataset is a seismic dataset that represents the partial spatial information of the area of interest.

14. The system of claim 11, wherein the input dataset is an input seismic cube that has a first dimension, and wherein each output dataset is an output seismic cube that has a second dimension larger than the first dimension.

15. The system of claim 11, wherein the input dataset is a photographic image dataset that represents the partial spatial information of the area of interest.

16. The system of claim 11, the operations further comprising:
training the machine learning model to generate, based on the partial spatial information, the contextual spatial information for the area of interest.

17. The system of claim 16, wherein the machine learning model is a conditional Generative Adversarial Network (cGAN), and wherein training the machine learning model comprises:
training a generator network of the cGAN to generate the contextual spatial information for the area of interest based on the partial spatial information, wherein the generator network is trained based on feedback received from a discriminator network of the cGAN, and wherein the discriminator network is configured to distinguish between real data and simulated data generated by the generator network.

18. A non-transitory computer-readable storage medium storing instructions executable by a computer system, the instructions when executed by the computer system cause the computer system to perform operations comprising:
receiving an input dataset that represents partial spatial information of an area of interest;
providing the input dataset to a spatial context generator, wherein the spatial context generator comprises a machine learning model trained to generate, based on the partial spatial information, contextual spatial information for the area of interest; and
using the spatial context generator to generate, based on the partial spatial information, at least one output dataset associated with the area of interest, wherein each output dataset comprises simulated contextual spatial information for the area of interest.

19. The non-transitory computer-readable storage medium of claim 18, wherein the machine learning model is a conditional Generative Adversarial Network (cGAN).

20. The non-transitory computer-readable storage medium of claim 18, wherein the input dataset is a seismic dataset that represents the partial spatial information of the area of interest.
